(19) United States
(12) Patent Application Publication
(10) Pub. No.: US 2021/0224970 A1
(43) Pub. Date: Jul. 22, 2021

(54) METHOD FOR ESTIMATING MEASURABLE PROPERTIES IN A THREE-DIMENSIONAL VOLUME OF MATERIAL

(71) Applicant: BIORETICS S.R.L., Cesena (FC) (IT)

(72) Inventor: Matteo ROFFILLI, Cesena (FC) (IT)

(21) Appl. No.: 17/056,364

(22) PCT Filed: May 16, 2019
(86) PCT No.: PCT/IB2019/054072

§ 371 Date: Nov. 17, 2020

(30) Foreign Application Priority Data
May 18, 2018 (IT) 102018000005488

(51) Int. Cl. G06T 7/00; G06N 3/08; G06N 20/10

(52) U.S. Cl. CPC G06T 7/0002; G06N 3/08; G06T 2207/20084; G06T 2207/20081; G06N 20/10

(57) ABSTRACT

Method for estimating measurable properties in a three-dimensional volume of material, in particular, the present method providing for the estimation of physical, chemical, biological and/or statistical properties of a volume of material, be it solid, liquid or gaseous; wherein a two-dimensional digital image is obtained, representing a single projection of said volume, which is obtained from a single view position in transmissive or partially reflective mode and wherein said two-dimensional digital image is subjected to analysis by means of machine learning algorithms in supervised mode.

### FIELD OF APPLICATION OF THE PRESENT INVENTION

The present invention relates to a method for estimating measurable properties in a three-dimensional volume of material.

In particular, the present method provides for the estimation of physical, chemical, biological and/or statistical properties of a volume of material, be it solid, liquid or gas.

### PRIOR ART

Investigating quantitatively the internal properties of a material requires first of all having available as accurate information as possible of what the material contains within it. This can be achieved in different ways (destructive and otherwise), techniques (spectroscopy, incineration, thermo-gravimetry, chromatography, elementary or thermal or microscopic analysis, or other) and configurations, among which one of the most widely used methods consists in passing through the object an electromagnetic signal (generated by that which in slang is called the light source) of an appropriate frequency that interacts with the material and subsequently collects it by means of a suitable digital or analog acquisition sensor sensitive to the specific frequencies generated by the interaction and positioned at a specific angle defined view position.

In this context, the transmission mode occurs when the volume of material is placed within the optical path that joins the light source to the acquisition sensor. In turn, the partially reflexive mode occurs instead when the electromagnetic wave emitted by the source penetrates the volume only for a part of it and is then reflected at one or more specific angles, on the trajectory of one of which the acquisition sensor is placed. The latter will therefore capture information relating only to a portion of the volume of the material under examination. It is possible to insert appropriate lenses into the trajectory of the electromagnetic signal with the aim of modifying all or part of the trajectories in order to facilitate focusing and/or collection thereof.

In the prior art, the analysis of the interior of a material is carried out according to the purposes or by means of a single projection obtained from a single view position (e.g. single projection in the X-ray radiographic investigation) or through a series of projections from different view positions from which the interior of the material volume is then algorithmically reconstructed (e.g. TAC investigation). It is usually not possible to reconstruct the volume from a single projection as a single projection does not contain the minimum information necessary for an even approximate reconstruction, which instead becomes possible from two projections upwards. However, in the art it is believed that the greater the number of projections, the better the reconstruction will be.

Each technique carries with it pros and cons although all are directed to obtain the measure of interest that is as accurate as possible, both as a numerical value and as a spatial location of the measure.

Consider, for example, a bone fracture: the questions that are of interest are many and follow a path of approximation towards complete information. Is there a fracture? Where is the fracture? How large is the fracture? Are there other interested organs above or below the fracture? And so on.

A technique that makes it possible, in certain well-established setup configurations, to reconstruct the volume from a single view position is the holographic one. One of the main features of the holographic method applied to the analysis of three-dimensional volumes relates to the need to have special electromagnetic signal generation and acquisition devices that include a laser illuminator as well as special optical configurations capable of capturing the field-of-view signal. This configuration is not always applicable in the industrial field for different reasons:

(a) inability to illuminate the sample with a laser source,

(b) strong limitation in the size of the sample that can be analyzed,

(c) inability to place the sample inside the holographic instrument,

(d) slowness in the measurement process, and

(e) cost of the holographic apparatus which allows the use thereof only in high value-added fields.

### SUMMARY OF THE INVENTION

The present invention aims to propose a new and alternative solution to the solutions known thus far and in particular it is proposed to overcome one or more of the drawbacks or problems referred to above and/or to meet one or more requirements which can be deduced from the above description.

A method is provided for estimating measurable properties in a three-dimensional volume of material, in particular, the present method providing for the estimation of physical, chemical, biological and/or statistical properties of a volume of material, be it solid, liquid or gaseous; characterized in that a two-dimensional digital image is obtained, representing a single projection of said volume, and which is obtained from a single view position in transmissive or partially reflective mode; and in that said two-dimensional digital image is subjected to analysis by means of machine learning algorithms in supervised mode.

In this way, the statistical techniques implemented by the present method allow estimating from the acquired image the value of the property of interest, even without knowing the structure of the material under examination.

In fact, if the need is to infer macroscopic and/or statistical properties, such as for example the density and/or the presence or absence of objects and/or their density and/or their spatial distribution and/or their geometric measurement, it is not necessary to first solve the problem of extracting the useful signal and then derive the properties of interest therefrom.

In fact, it is possible to directly estimate the value of the property without going through the knowledge of the captured signal and avoiding the need to have a favorable signal-to-noise ratio.

### BRIEF DESCRIPTION OF THE DRAWINGS

This and other innovative aspects are, however, set forth in the appended claims, the technical features whereof can be found, together with corresponding advantages achieved, in the following detailed description, illustrating embodiments which are merely illustrative and not limiting of the invention, and which is made with reference to the accompanying drawings, in which:

FIG. 1 shows a schematic view of a preferred embodiment of apparatus for detecting a two-dimensional digital image in transmissive mode;

FIG. 2 shows a schematic view of a preferred embodiment of apparatus for detecting a two-dimensional digital image in partially reflective mode.

### DETAILED DESCRIPTION OF PREFERRED EMBODIMENTS OF THE INVENTION

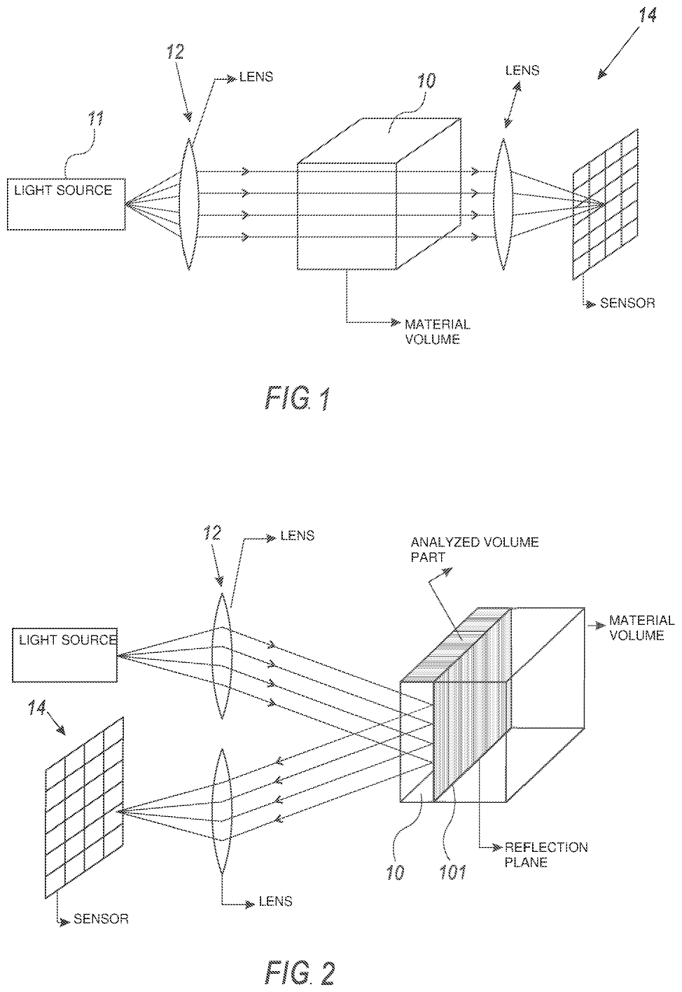

According to the present method, the analyzed signal is obtained by illuminating the three-dimensional sample 10 with common light sources 11 that are not coherent (e.g. LEDs) or coherent (e.g. lasers) and by focusing the transmitted signal, through special focusing apparatuses 12, on a two-dimensional plane (focus plane) which is acquired by a digital sensor (e.g. camera) 14, as can be inferred from the apparatus operating in transmissive mode illustrated in FIG. 1.

In a variant of the method, in which the components which are similar or equivalent to those illustrated in the first version of apparatus are marked with the same numerical references and, in order not to excessively burden the present description, are not described in detail again, the light source 11 and the digital acquisition sensor 14 are placed on the same side of the material 10 under examination. In this second configuration, the sensor 14 collects the information coming from a first layer 10′ of the material, within which the incoming electromagnetic signal has been transmitted and then reflected, as can be seen from the apparatus operating in partially reflective mode illustrated in FIG. 2.

The present method is based on the consideration that the electromagnetic signal emitted by the light source (in the visible band, X, terahertz, etc.) when passing through the material under examination acquires information relating to the properties to be measured.

Following, in fact, interactions with the physical-chemical structure of the material (for example stratification of different materials) and any objects it contains (for example in the form of particles suspended in a fluid, such as impurities in hydrocarbons, or in the form of stones set in minerals, oil fields and/or gases in the subsoil and/or underwater in the sea, or other) the electromagnetic signal will be diverted, reflected, refracted and/or diffracted, creating, in the projection acquired by the sensor, specific peculiar two-dimensional patterns depending on the composition of the material and the size and arrangement of any objects it contains.

The numerical intensity values acquired by the sensor can, in fact, be interpreted as the sum of all the interaction patterns and their relative interactions, produced by the electromagnetic signal when it interacts with the material during its crossing.

These specific patterns occur as minimal statistical structured fluctuations in space and buried in the totality of the acquired signal, usually with a very unfavorable signal-to-noise ratio.

This type of estimation under very unfavorable signal-to-noise conditions can be easily implemented using algorithms that belong to the branch of Artificial Intelligence known as machine learning, both shallow learning (e.g. Support Vector Machine or Relevance Vector Machine), and deep learning type (e.g. Artificial Neural Network or Convolutional Neural Network).

According to the present invention, these algorithms, when applied to the problem in question, require to be used in supervised mode, that is to say, having previously made available a dataset, usually very large, of vector/label pairs, in which the numerical vector represents the sample acquired and the label the real measure of the property of interest, obtained independently by an observer external to the algorithm and which is precisely called “supervisor”.

The creation of the aforementioned dataset requires the production of a large number of images (the vector) of the material under examination and, for each of these, the exact or approximate measurement (the label) of the property, to be estimated then by statistical means.

This goal can be achieved mainly in two ways:
a) creating particular standard samples of the material whose properties are known a priori by design (for example, plastic phantoms in mammography); however, this is not applicable to processes of natural origin that cannot be modeled (in fact, if they could be modeled analytical equations would be used to estimate their properties), or for which the production process inherently does not allow the exact definition of the measure (e.g. deposit of subsequently layering material);
b) producing samples of materials for which it is possible with techniques, also destructive, outside the survey method to obtain a measure of the property of interest. For example, if one was interested in measuring optically the degree of mineral impurities of a chemical solution (e.g. hydrocarbon), one could on the one hand acquire an image of a known volume of the solution and at the same time analyze the volume to derive the amount of impurities.

Once the dataset has been produced it is therefore possible to train in supervised mode one of the algorithms mentioned above in order to obtain a model, with the relative parameters, able to estimate the property of interest (of the volume) starting from the corresponding two-dimensional image.

Once the statistical evaluation has shown its validity, the model can be used in inference to estimate the value of the property of interest in samples never seen of the same nature as those present in the dataset.

If one is interested in multiple properties at the same time, more models are trained in parallel, or multi-class versions of the same models are used.

In particular, if an Artificial Neural Network (ANN) is used, the method consists of two steps:
step (1): search for optimal parameters (w) of the ANN (training/learning step),
step (2): application in production of the “ANN_w” (ANN with parameters set w) to new samples (test/inference step). Step (1) takes place in supervised mode, i.e. to find the parameters w it is necessary to have available a dataset of samples (x) to which the correct label (y) is associated.

Normally, the ANN parameter search algorithm uses the pairs (x, y) in an appropriate way and returns the values of (w) (also Support Vector Machine (SVM) and Relevance Vector Machine (RVM) operate in the same way, and in fact ANN and SVM and RVM are interchangeable with each other).

In particular, (x) is obtained through a non-destructive investigation of the sample (e.g. image in transmission) and (y) is usually obtained through the intervention of an individual (the supervisor) who by observing (x) establishes the correct (y).

The ANN (and the SVM/RVM) in fact try to reproduce by statistical means (ANN with many examples, SVM/RVM with few) the relation function (f) which associates (y) to (x) using the supervisor individual as a model to reproduce.

In this case, however, it appears to be quite obvious that if an individual is unable to establish the correct (y) by looking at (x), the supervised method is not applicable as there is no (f) to be reproduced.

This is the prior art today and it is theoretically not possible to overcome unless the paradigm is changed (from supervised to non-supervised).

In particular, according to the present inventive method, however, the problem is circumvented by providing a modified setup, which can be referred to as “privileged supervision”, and this is because ancillary and privileged information is only available to the supervisor.

In fact, it is expected that instead of asking a supervisor to observe (x), one asks him to observe (x′), which is a variant of (x), whose label (y′) is by construction strongly correlated/equal to (y).

The observation of (x′) is easier (and usually the technique to produce x′ is destructive of the sample) and allows the supervisor to easily define the correct label (y′).

If possible by construction, (x′) directly implies its own label (y′) according to a function (g) known a priori (e.g. infrared image where by definition the white above a certain quantitative threshold corresponds to a biological tissue and the black to a non-organic one).

In summary: the new setup provides to the algorithm that controls ANN/SVM/RVM:
(x) the original sample,
(x′) an alternative version of the original sample (x),
(y′) the label of (x′) extracted by a function (g) known a priori or easy to model.

Thereafter, having the pair (x, x′) available and knowing that g (x′)=(y′) and that (y′ implies y) or equivalently (y=y′), one gets the pair (x, y) which is what desired to proceed with the parameter estimation (w).

So, having found the parameters (w) one gets (f) which, when applied to (x), produces (y).

This is possible because the knowledge of the supervisor (f) and of the function (g) is incorporated in the construction mode of (x′).

Advantageously, said alternative version (x′) of the original sample (x) can therefore be obtained through a destructive technique of the same sample.

Therefore, during the test step, only the samples (x) will be produced and from these, by (f), in particular by means of the “ANN_w”, their label (y) will be calculated, as desired.

This mode is not transfer learning nor multi-modal learning which propose similar setups but conceptually distinct from the one presented herein.

### APPLICATION EXAMPLE

### Analysis of Cell Quantities in Histology

In the specific case, the application of the method proposed to histology is performed as follows:
obtaining (x), or the original image of the 3D sample of histological material, obtained in transmission or in partial reflection, using a microscope in clear light (which does not express fluorescence)
obtaining (x′), or the original image of the same 3D sample of histological material, obtained in transmission or in partial reflection, but using a different light source that makes the cells visible in fluorescence. This investigation is destructive because the cells must be chemically labeled (staining) to express fluorescence.

In particular, (g) is the statistical count (sum or variance) of the amount of fluorescence per unit of measurement (e.g. intensity/pixel\hat{ }2) which defines (y′) as the cell density in scale [0-100] (that is, the label 0 is equivalent to “no cell present in the sample” and the label 100 is equivalent to “a sample completely saturated with cells”).

In particular, as can be seen from the above, the present method is able to estimate physical, biological, statistical and/or chemical properties in a three-dimensional volume of material.

Furthermore, as mentioned, the material can be solid, liquid or gaseous, i.e. the material can be in the form of a liquid with cells in suspension, or in the form of a substrate, for example woody or ferrous, with a coating layer deposited above, for example a layer of plastic material and whose thickness is to be known by a non-destructive technique.

As mentioned above, it is also contemplated that the production mode of the projection or image is transmissive (FIG. 1), or that it is partially reflective (FIG. 2).

Moreover the light source can be of any frequency or composition of frequencies and/or the acquisition sensor can be of digital type or of analog type, that is to say, one starts from a picture on a photographic film which is then appropriately digitized.

Moreover, the present method is adapted to be implemented in a digital image processing and analysis apparatus.

The present invention is susceptible of evident industrial application. The man in the art will also be able to devise numerous modifications and/or variations to be made to the same invention, while remaining within the scope of the inventive concept, as extensively explained. Moreover, the man skilled in the art will be able to devise further preferred embodiments of the invention which include one or more of the above illustrated features of the preferred embodiment. Moreover, it must also be understood that all the details of the invention can be replaced by technically equivalent elements.

1. A method for estimating measurable properties in a three-dimensional volume of material, in particular, the present method providing for the estimation of physical, chemical, biological and/or statistical properties of a volume of material, be it solid, liquid or gaseous; wherein a two-dimensional digital image is obtained, representing a single projection of said volume, and which is obtained from a single view position in transmissive or partially reflective mode; and in that said two-dimensional digital image is subjected to analysis by means of machine learning algorithms in supervised mode.

2. The method according to claim 1, wherein the learning algorithm is of the shallow learning type, for example Support Vector Machine or Relevance Vector Machine.

3. The method according to claim 1, wherein the learning algorithm is of the deep learning type, for example Artificial Neural Network or Convolutional Neural Network.

4. The method according to claim 1, wherein it comprises two steps:
step (1): search for optimal parameters (w) of the machine learning algorithm (training/learning),
step (2): application in production of the machine learning algorithm with parameters (w) to new samples (test/inference), and with step (1) that takes place in supervised mode.

5. The method according to claim 4, wherein, in order to perform the setup, or to search for the optimal parameters (w) of the machine learning algorithm, the following is provided:
(x) the original sample,
(x′) an alternative version of the original sample (x),
(y′) the label of (x′) extracted by a function (g) known a priori or easy to model, so that, having available the pair (x, x′) and knowing that g(x′)=(y′) and that (y′ implies y) or equivalently (y=y′), we obtain the pair (x, y) with which one can proceed to estimate the optimal parameters (w) of the machine learning algorithm.

6. The method according to claim 5, wherein the alternative version (x′) of the original sample (x) is obtained by means of a destructive technique of the same sample.

7. The method according to claim 1, wherein the dataset, of vector/label pairs for training in supervised mode the machine learning algorithm is obtained by
a) creating particular standard samples of the material whose properties are known by design a priori beforehand; or
b) producing samples of materials for which it is possible with techniques, in particular also destructive, outside the survey method to obtain a measure of the property of interest.

8. The method according to claim 1, wherein the material is homogeneous.

9. The method according to claim 1, wherein the material is composite, for example it is in the form of a liquid with cells in suspension, or in the form of a substrate, for example woody or ferrous, with a coating layer deposited above, for example a layer of plastic material and whose thickness is to be known by a non-destructive technique.

10. The method according to claim 1, wherein the production mode of the projection is transmissive.

11. The method according to claim 1, wherein the production mode of the projection is partially reflective.

12. The method according to claim 1, wherein the light source is of any frequency or composition of frequencies.

13. The method according to claim 1, wherein the acquisition sensor is digital or analog, that is, starting from a picture on a photographic film which is then digitized.

14. The method according to claim 1, wherein it is adapted to be implemented in a digital image processing and analysis apparatus.

15. An apparatus adapted to implement a method as claimed in claim 1.

16. Method and apparatus, each characterized respectively in that it is implemented according to claim 1 and/or as described and illustrated with reference to the accompanying drawings.
